(19) United States
(12) Patent Application Publication
(10) Pub. No.: US 2026/0220955 A1
(43) Pub. Date: Jul. 30, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YUKI OSHIMA, Tokyo (JP)

(21) Appl. No.: 19/425,739

(22) Filed: Dec. 18, 2025

(30) Foreign Application Priority Data
Jan. 29, 2025 (JP) 2025-012772

(51) Int. Cl. G06V 30/10; G06V 20/62

(52) U.S. Cl. CPC G06V 30/10; G06V 20/62

(57) ABSTRACT

Designation of an area is received from a user on a first image, a type of a character string identified by estimation processing based on the character string included in the designated area, and a character string corresponding to the saved type that is extracted from multiple character strings recognized from a second image.

### BACKGROUND

### Field of the Technology

The present disclosure relates to a technique to extract a character string corresponding to a predetermined item from a document image.

### Description of the Related Art

Conventionally, there is a system that extracts a character string (in the following, called “idx character string”) corresponding to a predetermined item such as, for example, title, document number, issue date, company name, and amount from a scanned image obtained by scanning a paper document such as a business form by an image reading apparatus. In the system as described above, in order to correctly extract a desired idx character string from the scanned image, a user needs to designate contents of an item (item attribute) that the idx character string as an extraction target represents, by using a UI. In this context, there is a technique to precisely extract the idx character string from a document with a fixed layout (typical document) by setting an area-based extraction rule, which defines an area in the scanned image from which the idx character string is extracted, for each document type in advance. Additionally, there is a technique to create an extraction rule for a document with an unfixed layout (atypical document) based on an extraction target area designated by the user and a character area (item name candidate area) including an extracted term near the extraction target area (Japanese Patent Laid-Open No. 2020-205012).

The method of Japanese Patent Laid-Open No. 2020-205012 assumes that there is the extracted term near the extraction target area. That is, in a case of a document including no extracted term near the extraction target area, it is impossible to create a proper extraction rule. In this case, the user has no choice but to abandon the extraction of the idx character string using the system or to directly apply the area-based extraction rule, which is not adapted basically. As a result, in the former case, it is necessary to manually input a character string of a desired item, and in the latter case, it is necessary to manually correct the improperly extracted idx character string, which creates extra work for the user.

### SUMMARY

An information processing apparatus according to the present disclosure is configured to receive designation of an area from a user on a first image, save a type of a character string identified by estimation processing based on the character string included in the designated area, and output a character string corresponding to the saved type that is extracted from multiple character strings recognized from a second image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of a system;

FIG. 2 is a diagram illustrating a hardware configuration example of an image formation apparatus;

FIG. 3 is a diagram illustrating a functional configuration example of the image formation apparatus;

FIG. 4 is a flowchart illustrating a flow of filing of a document;

FIG. 5 is a flowchart illustrating details of idx character string extraction processing;

FIG. 6A and FIG. 6B are diagrams describing block selection;

FIG. 7 is a diagram illustrating an example of a document record;

FIG. 8 is a diagram illustrating an example of a result of performing estimation of a document type and an extraction target item;

FIG. 9A is a diagram illustrating an example of a UI screen to set property information;

FIG. 9B is a diagram illustrating an example of the UI screen to set the property information;

FIG. 9C is a diagram illustrating an example of the UI screen to set the property information;

FIG. 9D is a diagram illustrating an example of the UI screen to set the property information;

FIG. 9E is a diagram illustrating an example of the UI screen to set the property information;

FIG. 10 is a flowchart illustrating details of AT extraction rule registration processing; and

FIG. 11 is a flowchart illustrating details of the AT extraction rule registration processing according to a modification.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <System Configuration>

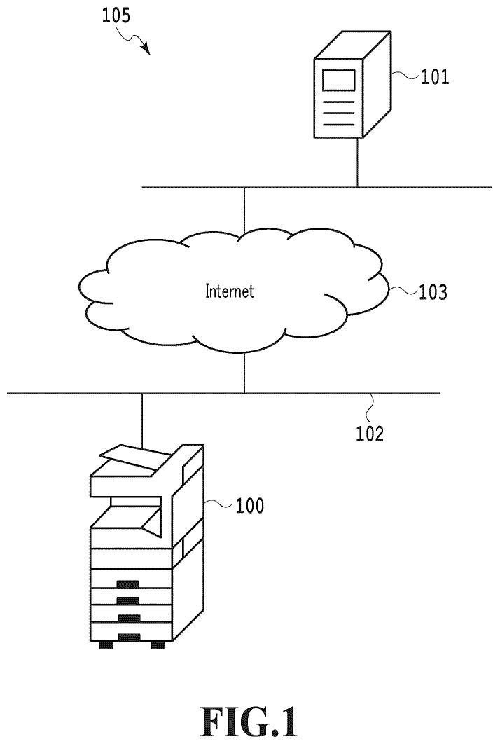

FIG. 1 is a diagram illustrating an overall configuration of a system to which the present embodiment is applicable. A system 105 of the present embodiment includes an image formation apparatus 100 and a terminal 101, both of which are information processing apparatuses. As illustrated in FIG. 1, the image formation apparatus 100 is connected to a LAN 102 and is communicable with the terminal 101, such as a PC, via the Internet 103 or the like. The image formation apparatus 100 is a multi function peripheral (MFP) that is a single device combining functions of copying, faxing, printing, scanning, and so on. Note that, in the present embodiment, the terminal 101 may be unnecessary, and a configuration including only the image formation apparatus 100 may be applicable. Additionally, in the present embodiment, as for each processing described later that is described to be performed by the image formation apparatus 100, a part of or all of the processing may be implemented by an external image processing apparatus (for example, a cloud server connected via the Internet).

### <Hardware Configuration of Image Formation Apparatus>

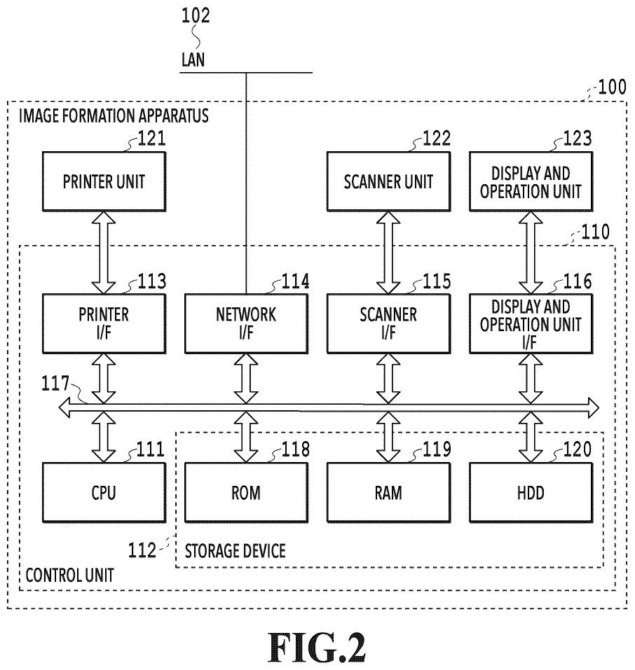

FIG. 2 is a block diagram illustrating a hardware configuration of the image formation apparatus 100. The image formation apparatus 100 of the present embodiment includes a control unit 110, a printer unit 121, a scanner unit 122, and a display and operation unit 123.

The control unit 110 includes a CPU 111, a storage device 112 (a ROM 118, a RAM 119, and an HDD 120), a printer I/F 113, a network I/F 114, a scanner I/F 115, and a display and operation unit I/F 116. Additionally, the units in the control unit 110 are communicably connected to each other via a system bus 117. The control unit 110 controls operations of overall the image formation apparatus 100.

The CPU 111 reads and executes a control program stored in the storage device 112 and implements reading control, image processing, printing control, display control, communication control, and the like in the flowcharts described later.

The storage device 112 stores and holds the control program, image data, metadata, setting data, processing result data, and the like. The storage device 112 includes the ROM 118 that is a non-volatile memory, the RAM 119 that is a volatile memory, the HDD 120 that is a high-capacity storage area, and so on. The ROM 118 is a non-volatile memory holding the control program and the like, and the CPU 111 reads the control program and performs control. The RAM 119 is a volatile memory used as a main memory of the CPU 111 and a temporal storage area such as a working area.

The network I/F 114 connects the control unit 110 (the image formation apparatus 100) to the LAN 102 via the system bus 117. The network I/F 114 transmits the image data to an external apparatus on the LAN 102 and receives various types of information from the external apparatus on the LAN 102.

The scanner I/F 115 connects the scanner unit 122 to the control unit 110 via the system bus 117. The scanner unit 122 generates the image data (scanned image data) by optically reading a document and inputs the scanned image data to the control unit 110 via the scanner I/F 115. Note that, the scanner unit 122 includes a document feeder and can feed multiple documents placed on a tray one by one and read the documents sequentially.

The display and operation unit I/F 116 connects the display and operation unit 123 to the control unit 110 via the system bus 117. The display and operation unit 123 displays a presentation result of a file name and a storage destination and displays a user interface to receive an instruction from a user. The display and operation unit 123 includes a liquid crystal display unit having a touch panel function, a hardware button, and the like.

The printer I/F 113 connects the printer unit 121 to the control unit 110 via the system bus 117. The printer unit 121 receives the image data generated by the CPU 111 via the printer I/F 113, and print processing on print paper is performed by using the received image data.

### <Functional Configuration of Image Formation Apparatus>

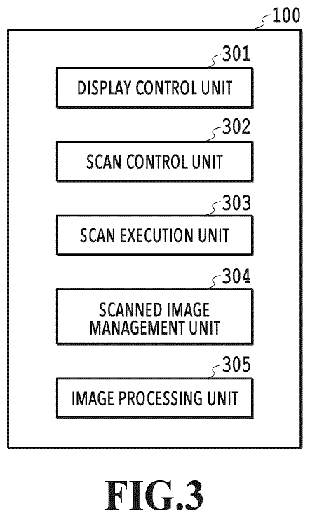

FIG. 3 is a block diagram illustrating a functional configuration (software configuration) of the image formation apparatus 100. Note that, FIG. 3 illustrates some of the functions of the image formation apparatus 100 that are narrowed down to the functions related to processing from scanning and digitalizing (filing) the document to saving the document.

A display control unit 301 displays a user interface screen (UI screen) to receive various user operations on the touch panel of the display and operation unit 123. The various user operations include, for example, scan setting, scan start instruction, correction instruction of extracted character string, file name setting, file saving instruction, and the like.

A scan control unit 302 instructs a scan execution unit 303 to execute scan processing according to the user operation received on the UI screen (for example, pressing a “scan start” button). In a case of the instruction to execute the scan processing, information on the scan setting is provided together. According to the instruction to execute the scan processing from the scan control unit 302, the scan execution unit 303 causes the scanner unit 122 to execute the reading operation of the document via the scanner I/F 115 and generates the scanned image data. The generated scanned image data is saved in the HDD 120 by a scanned image management unit 304.

An image processing unit 305 performs processing on the scanned image data, which is image analysis processing such as block selection processing, OCR processing (character recognition processing), and determination processing of similar documents, as well as image processing such as rotation and inclination correction. With the image processing unit 305, the image formation apparatus 100 also functions as an image processing apparatus. Note that, details of the image processing by the image processing unit 305 are described later.

The function of each unit in FIG. 3 is implemented with the CPU of the image formation apparatus 100 deploying the program code stored in the ROM to the RAM to execute. Alternatively, a part of or all the functions of each unit in FIG. 3 may be implemented by hardware such as an ASIC and an electronic circuit.

### <Filing of Document>

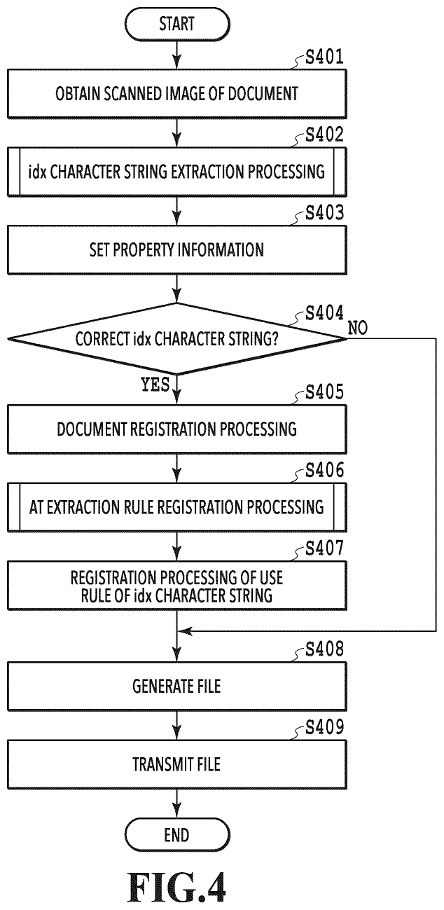

Subsequently, the filing of the document by the image formation apparatus 100 is described. In the filing of the document, a series of processing is performed, in which the document is read first, the image processing is performed on the scanned image of the first page of the document, the file name is generated by using the character string included in the scanned image, and the generated file name is presented to the user through the display and operation unit 123. FIG. 4 is a flowchart illustrating a flow of the filing of the document. In the following, detailed description is provided along the flowchart in FIG. 4. Note that, the series of processing illustrated in the flowchart in FIG. 4 is implemented with the CPU 111 deploying the program code stored in the ROM 118 to the RAM 119 to execute. In the following description, a symbol “S” means a step, and the same applies to the subsequent flowcharts.

In S401, once receiving a scan instruction from the user via the display and operation unit 123, the scan control unit 302 takes out the documents set on the document feeder of the scanner unit 122 one by one and causes the scan execution unit 303 to execute scanning. Note that, in the present embodiment, it is assumed that the document as a target of the scanning is a bill, an estimate form, and so on that are generally called a business form. In addition, the above-described business form includes a typical document with a fixed layout and an atypical document with an unfixed layout. Thus, the scan control unit 302 obtains the scanned image of the document.

In S402, the image processing unit 305 analyzes the scanned image obtained in S401 and performs processing to extract the character string corresponding to a predetermined item on the scanned document (in the following, called “idx character string”) based on an extraction rule that has been registered. In this case, the extraction rule of the present embodiment includes an extraction rule depending on the document layout (having area dependency) and an extraction rule independent of the document layout (having no area dependency). In a case of the extraction rule having the area dependency, for each predetermined item as an extraction target, a position coordinate of a text block (character string area) of the character string corresponding to the predetermined item and a position coordinate of a text block around the character string corresponding to the predetermined item are set. On the other hand, in a case of the extraction rule having no area dependency, for each predetermined item as the extraction target, information (item attribute) indicating what the item represents (for example, whether it is a title of the document, a document number, issue date, a company name, or an amount) is set. The item attribute (type of character string) can be determined from a form and a context of the corresponding character string. In the following, in the present specification, the extraction rule having the area dependency is called an area-based extraction rule (written as “AR extraction rule”). Additionally, the extraction rule having no area dependency is called an item attribute-based extraction rule (written as “AT extraction rule”). The idx character string obtained from the scanned image based on the above-described extraction rules is used as the file name in a case of saving the scanned image or the metadata embedded to the file. Details of idx character string extraction processing in the present step are described later. Note that, an aspect of using the idx character string is not limited to generating the file name and applying the metadata. For example, the idx character string may be used to generate a folder path and also to generate a CSV file in which item values are comma-delimited. That is, “property information” in the present specification is a concept containing various data generated based on the scanned image data of the document.

In S403, the display control unit 301 performs setting of the property information, such as generating the file name and applying the metadata, based on the idx character string extracted in S402 (extracted character string) and a use rule described later. Then, the UI screen (confirmation and correction screen) including the extracted idx character string and the set property information is displayed to be presented to the user. Then, the display control unit 301 receives an input operation of confirmation or correction by the user regarding the presented property information. Note that, in a case where the extraction rule has not been registered or the extraction of the idx character string fails, the display control unit 301 displays a UI screen to prompt input of the character string to be set as the file name and the metadata instead of the above-described confirmation and correction screen and receives the input operation of the user. Based on the input operation by the user via the UI screen as described above, the presented (or corrected) file name and metadata are determined as the file name and the metadata of the scanned image. Details of property information setting processing are described later.

In S404, the processing executed next branches depending on whether the idx character string is corrected during the property information setting processing in S403. In this case, a case where the user designates a new item as the extraction target is also considered as the correction of the idx character string. In a case where the idx character string is corrected, S405 is executed next. In a case where the idx character string is not corrected, S408 is executed next.

In S405, the image processing unit 305 performs document registration processing regarding the scanned image obtained in S401. Details of the document registration processing are described later.

In S406, the image processing unit 305 performs registration processing of the extraction rule to extract the idx character string from the scanned image obtained in S401. Details of the extraction rule registration processing are described later.

In S407, the image processing unit 305 performs registration processing of the use rule that defines how to use the idx character string obtained in S402. In this case, the use rule includes target item information, a file naming rule, and a metadata addition rule. In the following, a target item attribute, the file naming rule, and the metadata addition rule are each described.

### <<Target Item Information>>

The target item information is information indicating the attribute of the item as the extraction target and is provided in the form of “item attribute: <title>, <distributing company name>, <billing number>, <billing date>, {zip code},” for example. In this case, the four attributes surrounded by “<” and “>” that are <title>, <distributing company name>, <billing number>, and <billing date> indicate that they are predefined item attributes (in the following, called “already-defined item attribute”). In addition, {zip code} surrounded by “{” and “}” indicates that it is an item attribute that is not predefined (in the following, called “undefined item attribute”). The undefined item attribute (in the above-described example, “zip code”) is named by editing (input operation) by the user in the property information setting processing in S403. As for the undefined item attribute, the AT extraction rule cannot be generated in the extraction rule registration processing in S406; for this reason, it is an item attribute that allows the idx character string to be extracted only by the AR extraction rule.

### <<File Naming Rule>>

The file naming rule defines how to generate the file name by using the idx character string of the item identified by the target item information and is provided in the form of “file name: <title>_<distributing company name>_<billing number>.pdf,” for example. In a case of this example, it is indicated that the file name is generated by connecting the character string corresponding to <title>, the character string corresponding to <distributing company name>, and the character string corresponding to <billing number> in this order by an underscore as a separator.

### <<Metadata Addition Rule>>

The metadata addition rule defines the character string from the idx character strings of the items identified by the target item information that is to be applied as the metadata and is provided in the form of “metadata: <billing date>, {zip code},” for example. In a case of this example, it is indicated that the character strings corresponding to <billing date> and {zip code} are applied as the metadata of the file.

Note that, in the file name generation and the metadata addition, the character string other than the character string extracted as the idx character string may be used (for example, system information such as main body time).

In S408, the image processing unit 305 performs the filing of the scanned image obtained in S401 by using the property information (file name and metadata) determined in S403. In the present embodiment, as an example, it is described that the filing of the scanned image is performed in the form of Portable Document Format (PDF). In a case of PDF, it is possible to save the image data by page units, and in a case where multiple documents are scanned in S401, the scanned images corresponding to the documents are each saved as individual pages in a single file.

In S409, the scanned image management unit 304 transmits the file generated in S408 to a predetermined transmission destination through the LAN 102.

The above is a rough flow of the filing of the document by the image formation apparatus 100. Note that, although it is described assuming that the processing is performed by the image formation apparatus 100 by itself, a part of the processing may be performed by another apparatus. For example, the scan processing of the document is executed by the image formation apparatus 100, and the obtained scanned image is transmitted to the terminal 101 via a network. The terminal 101 may include a function unit similar to that of the image processing unit 305, and the idx character string extraction processing may be executed by the terminal 101. In this case, the terminal 101 may reply an extraction result of the idx character string to the image formation apparatus 100, and the image formation apparatus 100 may perform file generation and file transmission based on the obtained extraction result of the idx character string.

### <Idx Character String Extraction Processing>

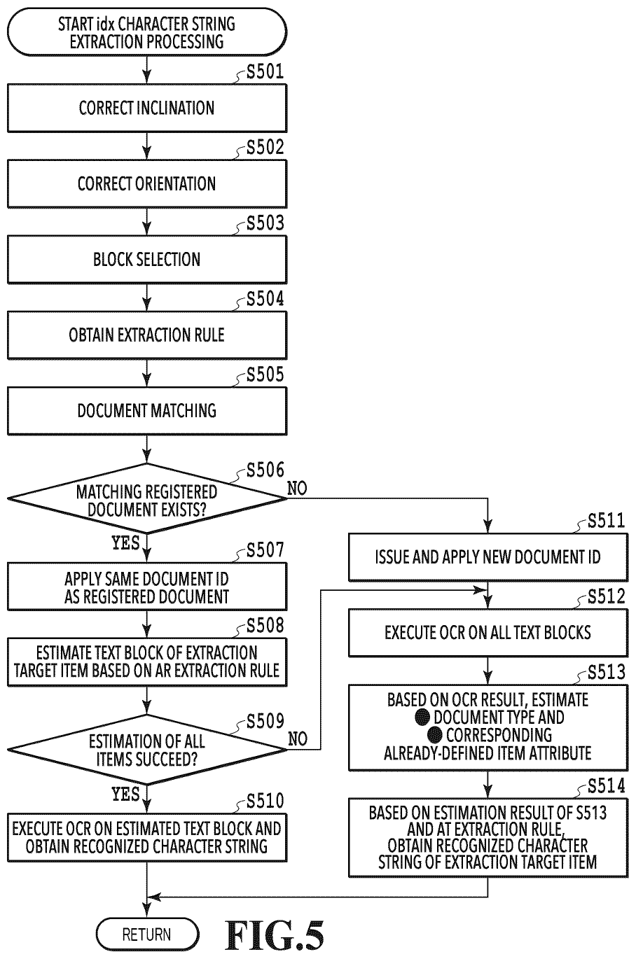

Subsequently, the idx character string extraction processing performed by the image processing unit 305 in S402 described above is described. FIG. 5 is a flowchart illustrating details of the idx character string extraction processing. In the following, detailed description is provided along the flowchart in FIG. 5.

In S501, processing of correcting inclination is performed on the scanned image of the page of interest as the processing target. Specifically, first, detection of the inclination (angle) of the scanned image is performed, and processing of rotating the scanned image of interest by the detected inclination in the opposite direction is performed. The inclination of the scanned image occurs because the document cannot be read straight due to abrasion of a roller and the like in the document feeder of the scanner unit 122 during scanning of the document, for example. Alternatively, the inclination occurs because the scanned document is not printed straight during printing. A method of detecting the inclination is as follows. First of all, an object included in the scanned image is detected, and object groups adjacent to each other in a horizontal direction or a vertical direction are coupled. Then, an angle of a connection between the center positions of the coupled object groups to the horizontal direction or the vertical direction is derived, and thus the inclination is obtained. Note that, the method of detecting the inclination is not limited to the above method. In addition, for example, a center coordinate of the object included in the scanned image may be obtained, center coordinate groups may be rotated by the unit of 0.1 degrees, and an angle at which the center coordinate groups are most likely arrayed in the horizontal direction or a perpendicular direction may be obtained as the inclination of the scanned image. The correction of the inclination of the scanned image makes it possible to increase an accuracy in each processing performed subsequently, such as rotation correction, block selection, and OCR.

In S502, orientation correction in which the image is rotated by the unit of 90 degrees is performed on the scanned image after the inclination correction such that the character in the image is in an upright orientation. A method of the orientation correction is as follows. First of all, using the scanned image after the inclination correction as a reference image, an image obtained by rotating the reference image 90 degrees, an image obtained by rotating the reference image 180 degrees, and an image obtained by rotating the reference image 270 degrees are additionally prepared. Then, simple OCR that can be processed at high speed is executed on each of the four prepared images, and the image including the greatest number of characters that are recognized with a certainty equal to or greater than a certain value is selected as the image after the rotation correction. Note that, the method of the rotation correction is not limited to the above method. Note that, in the following description, “scanned image” indicates the scanned image after the inclination and the orientation are corrected unless otherwise stated.

In S503, the block selection is performed on the scanned image. Block selection is processing of detecting the text block by categorizing the scanned image into a foreground area and a background area and then separating the foreground area into a character string area (text block) including the character string and an area other than the character string area. A method of the block selection is as follows. First of all, contour tracking is performed on the scanned image binarized into white and black, and a block of pixels surrounded by a black pixel contour is extracted. Then, in the block of the black pixels having an area greater than a predetermined size, contour tracking is also performed on a white pixel inside the block of the black pixels to extract a block of white pixels, and additionally, the block of the black pixels is extracted recursively from the inside of the block of the white pixels having an area equal to or greater than a certain size. The block of the black pixels obtained as described above is determined as the foreground area. Then, the determined foreground area is categorized as an area of the respective object attribute based on the size and the shape. For example, the foreground area of an aspect ratio close to “1” and the size within a certain range is determined as the pixel block corresponding to a character, and an area in which close characters may be grouped in good alignment is determined as the character string area (TEXT attribute). A flat pixel block is determined as a line area (LINE attribute). A range of a certain size or greater that is occupied by the black pixel block containing the white pixel blocks in good alignment is determined as a table area (TABLE attribute). An area including dispersed irregular pixel blocks is determined as a photograph area (PHOTO attribute). In addition, the pixel block having a shape other than the above is determined as a picture area (PICTURE attribute). Thus, from the areas divided for each object attribute, the foreground area determined to have the TEXT attribute is detected as “character string area (text block).”

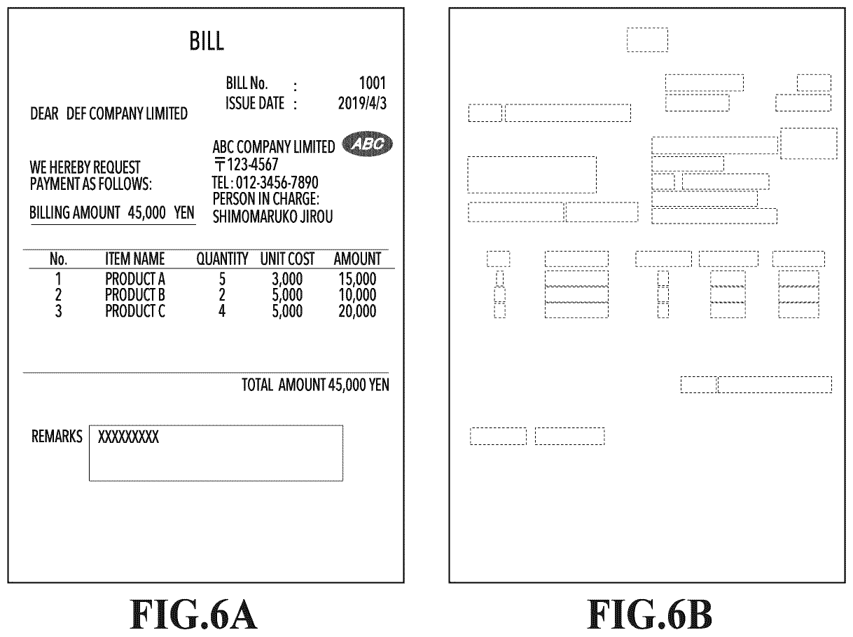

FIG. 6A and FIG. 6B are diagrams describing the block selection. FIG. 6A illustrates the scanned image, and FIG. 6B illustrates a result of the block selection performed on the scanned image in FIG. 6A. In FIG. 6B, a rectangle illustrated with a dotted line represents the text block. Information of each text block detected in the present step (information indicating the object attribute and position and size of the block) is used for the subsequent OCR, similarity calculation, and so on. Note that, the reason of detecting only the text block during the block selection in the present step is because the position of the character string expresses the structure of the scanned image well and is closely related to the extraction rule of the character string corresponding to the predetermined item. Accordingly, it does not mean to preclude the use of the information of the block determined to have another object attribute, such as the photograph area and the table area, in the subsequent processing.

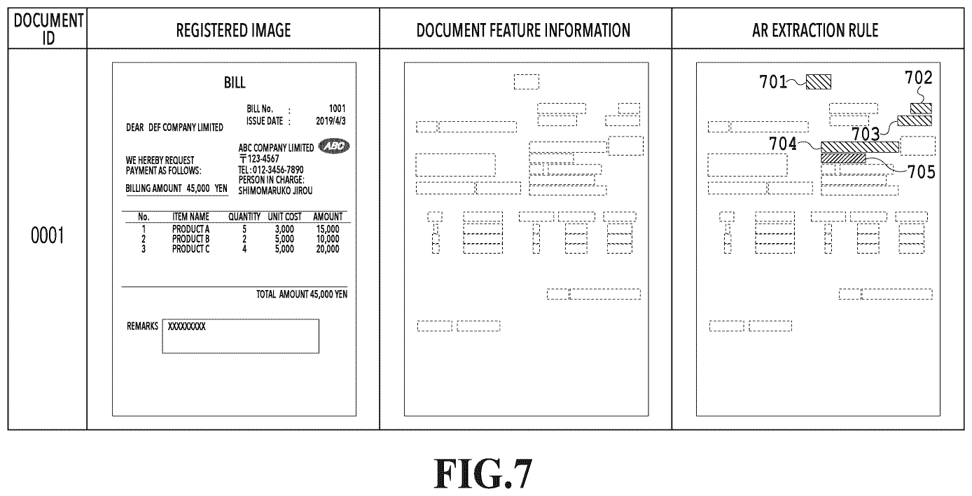

In S504, the extraction rule to extract the character string corresponding to the predetermined item from the scanned image is obtained from the HDD 120. Specifically, a document record group including the AR extraction rule for each registered document and the AT extraction rule common for various documents are obtained. The obtained extraction rule is deployed to the RAM 119. FIG. 7 is a diagram illustrating an example of a document record. The document record is formed of each data of “document ID,” “registered image,” “document feature information,” and “AR extraction rule,” and the document records are held in the HDD 120 by the number of the registered documents. Note that, in a case where the registered document is formed of multiple pages, each data of “registered image,” “document feature information,” and “AR extraction rule” exists by the number of the pages for each registered document. “Document ID” is a unique ID identifying the registered document. “Registered image” is the scanned image of the registered document, which may be an image down-converted to a resolution of about 150 dpi, for example, as long as the image holds the information that allows the user to understand the document contents. “Document feature information” is information of the position and the size of the text block obtained as a result of executing the block selection on the scanned image of the registered document. The document feature information is used to identify the registered document having a similar document layout as that of an inputted document during document matching in S505 described later. The document feature information is not limited to the information of the position and the size of the text block as long as it is information necessary to discriminate the similarity of the document layout. For example, the document feature information may hold a position and a shape of a ruled line included in the document, or a combination of the character strings that appear in the document may be used. “AR extraction rule” is information to extract the character string corresponding to the item as the extraction target based on the area in each processing in S508 and S510 described later. Each extraction area set for each item as the extraction target is identified by information of the coordinate and the size of the text block as the extraction target in the registered document. In FIG. 7, rectangles 701 to 704 hatched with oblique lines represent the extraction area of the already-defined item attribute, and a rectangle 705 hatched with dots represents the extraction area of the undefined item attribute. The AR extraction rule holds not only the information of the coordinate and the size of the text block as the extraction area but also the information of the coordinate and the size of the text block around the concerned text block as block pattern information. Thus, even in a case where the position, the number of lines, and the like of each item are changed depending on the written contents of the document, it is possible to extract the character string corresponding to each item. The AT extraction rule is information to extract the character string corresponding to the item as the extraction target based on the item attribute in processing in S514 described later. Details of the AT extraction rule are described later, and the AT extraction rule is formed of one or more item attributes as the extraction target and applied in the form of, for example, “item attribute: <title>, <distributing company name>, <billing number>, <billing date>.”

In S505, the document matching to discriminate the similarity of the document layout between the document according to the scanned image and the registered document is performed. The document matching can be paraphrased as processing of identifying the type of the inputted document by determining whether the document of the same type as the document according to the scanned image (inputted document) exists as the registered document in the document record group obtained in S504. In the document matching, whether the document types match is determined by calculating the similarity between the inputted document and each registered document based on the document feature information in each document record. In this case, the similarity is an index indicating how much the shape and the arrangement of the text block included in the scanned image of the inputted document similar to that of each registered document. A method of calculating the similarity is as follows. First of all, positioning between all the text blocks of the scanned image and all the text blocks of the registered document as a comparison target is performed. Then, the square of the sum of areas in which each text block of the scanned image and each text block of the registered document overlap is obtained (which is a value A). In addition, the product of the sum of the areas of the text blocks of the scanned image and the sum of the areas of the text blocks of the registered document is obtained (which is a value B). Then, a value obtained by dividing the value A by the value B is the similarity. The above-described processing is performed on each registered document of the document record group, and the registered document with the similarity that is equal to or greater than a predetermined value and is also the highest similarity is identified as the document of the same type as the inputted document. Note that, in a case where the registered document with the similarity that is equal to or greater than the predetermined value is not found, it is determined that the document of the same type as the inputted document has not been registered.

In S506, the processing executed next branches depending on whether the registered document of the same type as the inputted document is found as a result of the document matching in S505. If the registered document of the same type as the inputted document is found, S507 is executed next. On the other hand, if the registered document of the same type as the inputted document is not found, S511 is executed next.

In S507, the same document ID as the registered document identified as the same type is applied to the scanned image obtained in S401.

In S508, based on the AR extraction rule associated with the document ID applied in S507, processing of estimating the text block of the extraction target item in the scanned image obtained in S401 (extraction area estimation processing) is performed. Specifically, using the above-described block pattern information for each extraction target item, pattern matching is performed between the text block of the extraction target item and each text block included in the scanned image, and the block pattern similarity is calculated. Then, the text block with the calculated block pattern similarity that is equal to or greater than a threshold set in advance and is also the maximum similarity is estimated as the text block of the extraction target item (idx block). In a case where there is no text block with the calculated block pattern similarity that is equal to or greater than the threshold, it is estimated that no idx block corresponding to the extraction target item exists in the inputted document.

In S509, the processing executed next branches depending on whether the estimation of the idx block corresponding to all the extraction target items defined by the AR extraction rule of the registered document is succeeded.

If the estimation of the corresponding idx block is succeeded for all the extraction target items, S510 is executed next. On the other hand, if the estimation of the corresponding idx block fails for any one of the extraction target items, S512 is executed next.

In S510, partial OCR is executed on all the idx blocks from all the text blocks in the scanned image that are estimated in S508. Then, the recognized character string of each idx block obtained by the partial OCR is determined as the idx character string corresponding to the extraction target item. Thereafter, the processing returns to the flow in FIG. 4.

In S511, a new document ID is issued and applied to the inputted document. In the subsequent S512, whole-area OCR is executed on all the text blocks in the scanned image obtained in S401. In this process, if the estimation of the idx block corresponding to any one of the extraction target items fails (No in S509), from the recognized character strings obtained by whole-area OCR, the recognized character string obtained from the idx block of the extraction target item that succeeds to estimate the idx block in S508 is determined as the idx character string corresponding to the extraction target item.

In S513, based on the recognized character string obtained by the whole-area OCR in S512, the estimation of the document type for the inputted document and the corresponding already-defined item attribute is performed. For example, rule-based estimation is applied to the estimation. The rule-based estimation is an estimation method using a rule determined advance based on the position of the object and a font size in the document, a format of the character string, whether there is a particular key character string, positional relationship between the key character string and another character string, and the like. In the following, the estimation of the document type and the estimation of the corresponding already-defined item attribute are described separately.

### <<Estimation of Document Type>>

It is possible to estimate the document type of the inputted document (use application of the document) according to the particular key character string existing in the inputted document, for example. For example, in a case where the key character strings such as “billing,” “estimate,” “order,” and “delivery” exist in the inputted document, the inputted documents are estimated as “bill,” “estimate form,” “order form,” and “delivery slip” as the document type, respectively. In this process, for example, in some cases, the character strings of both “delivery” and “billing” exist in the inputted document. In this case, it may be considered as failing the estimation of the document type, or different degrees of priority may be provided to the key character strings based on the position, the size, the number of times of appearance, and the like of the text block to estimate the document type corresponding to either one of the character strings. Additionally, the document type, like “delivery slip and bill,” may be defined as the document that has multiple use applications, and the estimation result may be the defined document type.

### <<Estimation of Corresponding Already-Defined Item Attribute>>

The estimation of the corresponding already-defined item attribute can be paraphrased as processing of discriminating whether all the recognized character strings obtained by the whole-area OCR correspond to the character string of any one of the already-defined item attributes. As described above, the already-defined item attribute is formed of an abstract item attribute (first type of character string) and a detailed item attribute (second type of character string) corresponding to each abstract item attribute. The “abstract item attribute” means the item attribute common for various document types independent of the document type (kind of document), and the “detailed item attribute” means the item attribute obtained by detailing the abstract item attribute according to the document type. In the following Table 1, a list of an example of the already-defined item attributes is illustrated.

| | document type | | | |
|---|---|---|---|---|
| abstract item | | estimate | | delivery |
| attribute | bill | form | order form | slip |
| title | — | — | — | — |
| issue date | billing date | estimate | order date | shipping |
| | | date | | date |
| document number | billing | estimate | order | delivery |
| | number | number | number | number |
| issuing company | distributing | distributing | purchasing | distributing |
| name | company | company | company | company |
| total amount | billing | estimate | order | billing |
| | amount | amount | amount | amount |

In Table 1 mentioned above, for example, in <issue date> as the abstract item attribute, <billing date>, <estimate date>, <order date>, and <shipping date> are defined in association with the document type as the detailed item attribute of the abstract item attribute. There is no detailed item attribute exists in <title> as the abstract item attribute because <title> is the item attribute independent of the document type. For example, in addition to that indicated in Table 1 mentioned above, various abstract item attributes may be defined according to the use application such as <human name>, <address>, <zip code>, <payment method>, and <due date>. In a case of each abstract item attribute indicated in Table 1 mentioned above, it is possible to perform the estimation as follows.

Note that, in some cases, the estimation result includes an error. For example, in some cases, the character string “2019/4/3” indicating <document number> is improperly estimated to correspond to the character string of <issue date>.

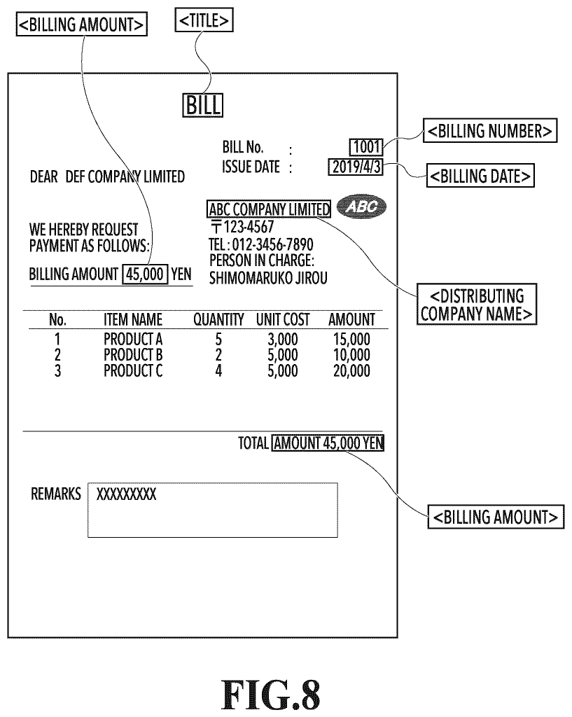

As described above, once the estimation of the abstract item attribute ends, subsequently, the estimation of the detailed item attribute is performed. The estimation of the detailed item attribute is performed based on an estimation result of the document type and an estimation result of the abstract item attribute. For example, in a case where the estimation result of the document type is “bill,” and the estimation result of the abstract item attribute is <issue date>, it is estimated that the detailed item attribute corresponding to <issue date> of the bill is <billing date>. Thus, the recognized character string estimated to correspond to the detailed item attribute and the position thereof are identified. Note that, in a case where the document type cannot be estimated, or as for the abstract item attribute for which no detailed item attribute is defined like <title>, the recognized character string estimated to correspond to the abstract item attribute and the position thereof are identified. FIG. 8 is a diagram illustrating an example of a result of performing the estimation of the document type and the extraction target item on the scanned image in FIG. 6A. In this example, first, based on the recognized character string “billing,” the document type is estimated as “bill.” In addition, it is estimated that the recognized character string “bill” corresponds to the abstract item attribute <title>. Additionally, it is estimated that the recognized character string “1001” corresponds to the abstract item attribute <billing number>. Moreover, it is estimated that the recognized character string “2019/4/3” corresponds to the abstract item attribute <billing date>. Furthermore, it is estimated that the recognized character string “ABC company limited” corresponds to the abstract item attribute <distributing company name>. In addition, it is estimated that the two recognized character strings “45,000” correspond to the abstract item attribute <billing amount>.

Note that, although the rule-based estimation is described herein, it is not limited thereto. For example, the estimation may be performed by using a large language model (LLM) that is a machine learning model learned in advance.

The LLM includes a Transformer model, a bidirectional LSTM, a Sequence2Sequence model, an RNN, and so on.

In S514, based on the estimation result obtained in S513 and the AT extraction rule included in the extraction rule obtained in S504, the recognized character string corresponding to the extraction target item is obtained as the idx character string. In this case, if the registered document of the same type as the inputted document is not found (No in S506), the recognized character strings corresponding to the item attributes of all the extraction targets defined by the AT extraction rule are obtained as the idx character strings. Now, the AT extraction rule is “item attribute: <title>, <distributing company name>, <billing number>, <billing date>.” In this case, from the scanned image in FIG. 8, the recognized character strings that are “bill” as <title>, “ABC company limited” as <distributing company name>, “1001” as <billing number>, and “2019/4/3” as <billing date> are obtained as the idx character strings. On the other hand, in a case where the registered document of the same type as the inputted document is found, but the estimation of the idx block corresponding to any one of the extraction target items fails (No in S509), the recognized character string corresponding to the item attribute of the extraction target item related to the failure is obtained as the idx character string. Thereafter, the processing returns to the flow in FIG. 4.

The above is the contents of the idx character string extraction processing. Note that, in the estimation in S513, in some cases, a result that multiple recognized character strings corresponding to the same already-defined item attribute exist in the document is obtained. In this case, for example, the recognized character strings obtained by the whole-area OCR in S512 are listed in a predetermined order of being read, and the recognized character string at the top is obtained as the idx character string. Alternatively, for example, the certainty of the position of the extraction area (extraction position certainty) may be obtained from the matching degree with the rule used for the estimation, and the recognized character string with the highest extraction position certainty may be obtained as the idx character string. Additionally, the multiple recognized character strings may be obtained first, and in the subsequent property information setting processing (S403), one recognized character string to be adopted as the idx character string may be selected by the user from the multiple recognized character strings. Note that, although a series of the processing illustrated in the flow in FIG. 5 is all executed by the image processing unit 305 in the present embodiment, the above-described idx character string extraction processing may be implemented with the server on the Internet executing a part of the processing, and the image processing unit 305 using the result.

### <Processing of Setting Property Information>

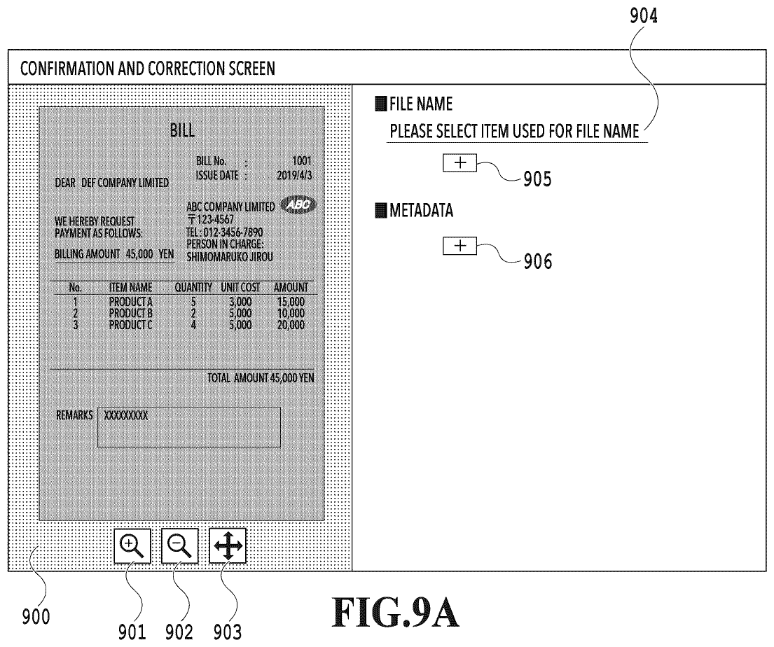

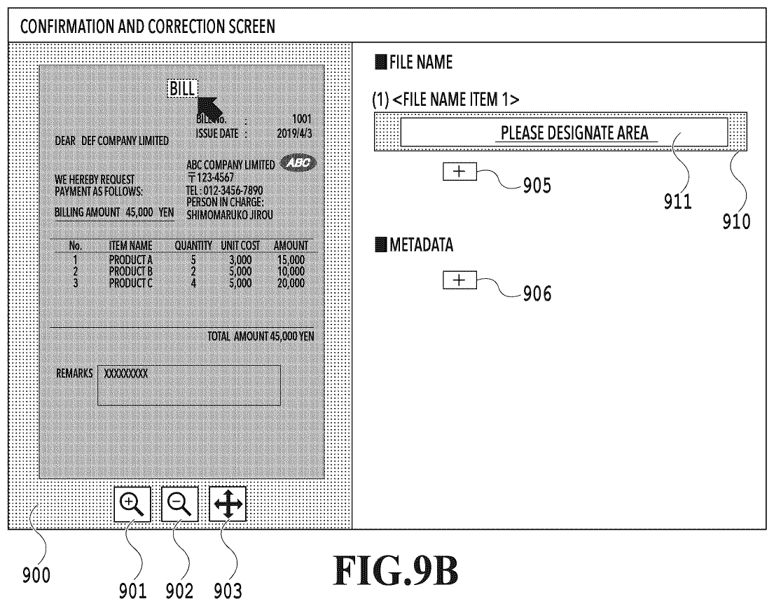

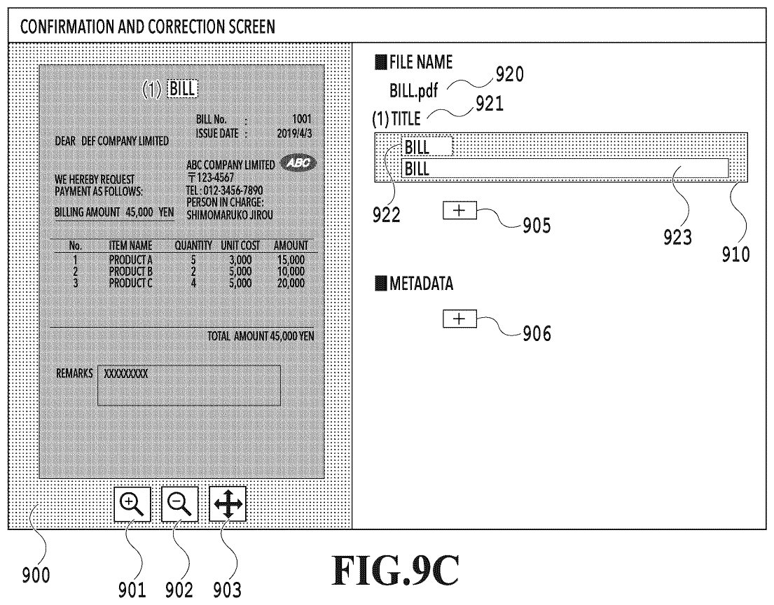

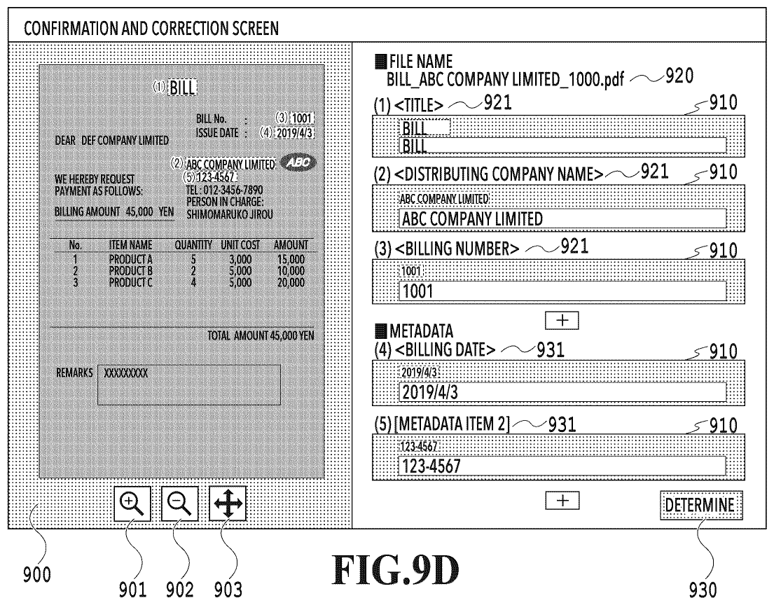

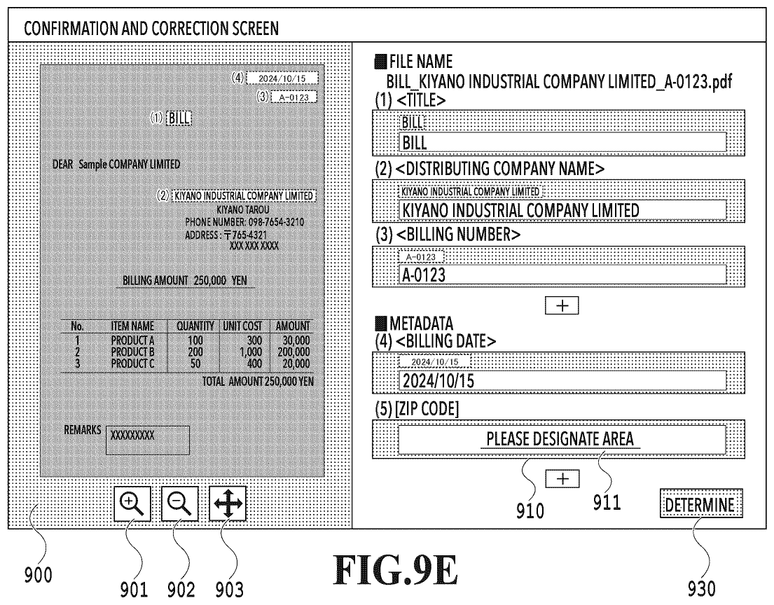

Next, processing of setting the property information performed by the display control unit 301 in S403 described above is described in detail. FIG. 9A to FIG. 9E are examples of the UI screen (confirmation and correction screen) to confirm and correct the character string used for the file name and the metadata that is referred by the user to set the property information. In the following, description is provided using the specific examples of the UI screen.

FIG. 9A illustrates a state of the confirmation and correction screen in a case where there is no registered document of the same type as the inputted document, and the AT extraction rule and the use rule of the idx character string are not generated yet. In a preview area 900 on a left side of the screen, the scanned image of the inputted document is displayed as a preview image. Buttons 901 and 902 are buttons to enlarge and contract a display magnification of the preview image. A button 903 is a button to enlarge or contract the preview image to be fitted with a width or a height of the preview area. In a case where the confirmation and correction screen in FIG. 9A is displayed, there is no extraction rule obtained in S504, and thus no idx character string is extracted. For this reason, the automatic generation of the file name using the idx character string is not performed as well, and a message 904 prompting the user to select the item used for the file name is displayed in the position where a file name candidate is originally displayed. A button 905 displayed below the message 904 is a button to add the item used for the file name. Additionally, a button 906 is a button to add the item used for the metadata. The user presses the button 905/the button 906 to designate the text block of the desired item to be used for the file name or the metadata. In a case where the user presses the button 905 from the state in FIG. 9A, the confirmation and correction screen transitions to the state in FIG. 9B.

An idx character string field 910 is displayed on a right side of the confirmation and correction screen in FIG. 9B.

In addition, in the idx character string field 910, a button 911 to designate the text block corresponding to the desired item is displayed. The user presses the button 911 and designates the text block corresponding to the desired item in the preview image by using a mouse and the like. Now, in the example in FIG. 9B, the text block of “bill” on the preview image is designated and displayed with a highlight. Once the text block corresponding to the desired item is designated as described above, the confirmation and correction screen transitions from the state in FIG. 9B to the state in FIG. 9C. On the confirmation and correction screen in FIG. 9C, a tentative file name “bill.pdf” using the recognized character string of the designated text block “bill” is displayed in a file name field 920. In addition, the item attribute of the designated text block <title> is displayed in an item attribute field 921 below the file name field 920. Moreover, inside the idx character string field 910, a partial preview area 922 and an idx character string field 923 are displayed. In the partial preview area 922, a partial image corresponding to the designated text block is cut out from the scanned image and displayed. In the idx character string field 923, the recognized character string “bill” extracted as the idx character string is displayed. In a case where the recognized character string displayed in the idx character string field 923 is wrong, the user can edit directly.

FIG. 9D illustrates the confirmation and correction screen in a state in which the text block of the item used for each of the file name and the metadata is designated after the above-described user operation. In the example in FIG. 9D, as the text block of the item used to generate the file name, the text block corresponding to each character string of “bill,” “ABC company limited,” and “1001” is designated.

As a result, based on the designation of the above text blocks, the already-defined item attributes <title>, <distributing company name>, and <billing number> are displayed in the corresponding item attribute fields 921, respectively. In addition, the partial image of the corresponding text block and the recognized character string extracted therefrom are displayed in the corresponding idx character string field 910. Moreover, the file name generated by combining the extracted idx character strings (or the character string edited by the user) according to the file naming rule is displayed in the file name field 920. Additionally, as the text block of the item used to apply the metadata, the text block corresponding to each character string of “2019/4/3” and “123-4567” is designated. As a result, as for the text block of “2019/4/3,” the already-defined item attribute <billing date> is displayed in an item attribute field 931. On the other hand, in the item attribute field 931 for the text block “123-4567,” {metadata item 2} indicating that it is the undefined item attribute name is displayed by default. The user can edit the name of the undefined item attribute, and in this example, the user edits {zip code} from {metadata item 2}. Once completing the confirmation or the necessary correction for the file name and the metadata as the property information, the user presses a determine button 930. With the determine button 930 being pressed, the items used for the file name and the metadata and the corresponding text blocks are determined for the scanned image being displayed.

FIG. 9E is an example of the confirmation and correction screen displayed during the filing of a new scanned image of the inputted document after the determine button 930 is pressed and the filing is completed in the state in FIG. 9D. Now, there is no new registered document of the same type as the inputted document. In this case, although the extraction based on the AR extraction rule cannot be performed, the idx character string is extracted by the AT extraction rule for the already-defined item attributes <title>, <distributing company name>, and <billing number>.

However, as for the undefined item attribute {zip code}, the extraction based on the AR extraction rule cannot be performed, and also the extraction of the idx character string based on the AT extraction rule cannot be performed. Therefore, the user presses the button 911 displayed in the idx character string field 910 corresponding to the undefined item attribute {zip code} and selects the text block corresponding to {zip code} on the preview image by using the mouse and the like to designate the desired character string. Thus, setting of the property information in a case of filing the scanned image is performed.

### <Document Registration Processing>

Next, the document registration processing performed by the image processing unit 305 in S405 described above is described in detail. In the document registration processing of the present embodiment, based on the result of the document matching in S505, either new registration or overwriting registration is performed. Thus, the document record as illustrated in FIG. 7 described above is accumulated and updated.

In the new registration, using the document ID newly issued in S511, the scanned image of the target document, the document feature information, and the AR extraction rule for all the extraction target items determined by the property information setting processing in S403 are newly registered. On the other hand, in the overwriting registration, using the document ID applied in S507 (the document ID of the matching registered document), the scanned image of the target document, the document feature information, and the AR extraction rule for all the extraction target items determined by the property information setting processing in S403 are overwritten.

### <AT Extraction Rule Registration Processing>

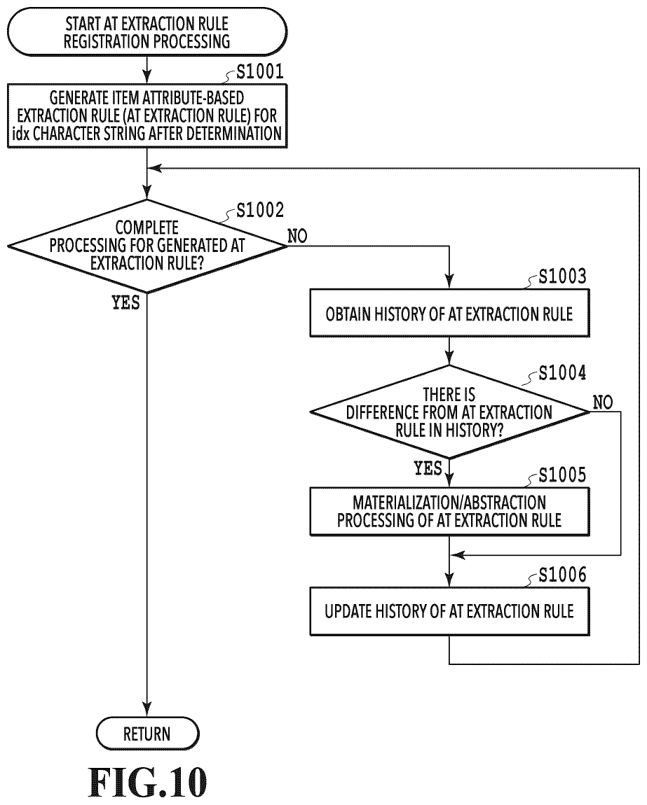

Next, the AT extraction rule registration processing performed by the image processing unit 305 in S406 described above is described. FIG. 10 is a flowchart illustrating details of the AT extraction rule registration processing. In the following, detailed description is provided along the flowchart in FIG. 10.

In S1001, the AT extraction rule that is the item attribute-based extraction rule is generated for the idx character string determined by the property information setting processing in S403. For example, in a case of the preview image on the confirmation and correction screen in FIG. 9D described above, the idx character strings after the determination are the five character strings, which are “bill,” “ABC company limited,” “1001,” “2019/4/3,” and “123-4567.” The AT extraction rule is generated based on the character string from the five character strings that corresponds to the already-defined attribute item. In other words, the AT extraction rule of “item attribute: <title>, <distributing company name>, <billing number>, <billing date>” is generated. Note that, the character string “123-4567” is not included in the AT extraction rule since {zip code} is the undefined item attribute and is not the estimation target in S513 described above.

In S1002, whether there is the item attribute included in the generated AT extraction rule that is not processed yet is determined. If there is the item attribute not processed yet, S1003 is executed next.

On the other hand, if the processing for all the item attributes in the generated AT extraction rule is completed, the present processing ends, and the processing returns to the flow in FIG. 4.

In S1003, history information of the AT extraction rule is obtained. In the present embodiment, control is performed such that the contents of the latest predetermined number of times of the AT extraction rules (for example, the last three) are held in the HDD 120 as the history information, and in the present step, the history information being held is read and obtained from the HDD 120. In this case, the contents held as the history information are not limited to the entirety of the AT extraction rule generated. For example, the number of times the rule has appeared for each item attribute, the position of the target item in the document, the layout around the target item, a success rate of the extraction for each item attribute, the certainty of the extraction position for each item attribute, and the like may be the history information. Additionally, although the latest predetermined number of times of the AT extraction rules are held in the present embodiment, the method of managing the history information is not limited to the number of times, and the history information may be managed according to a period of time such that the AT extraction rule that is 30 days after being generated is deleted from the history, for example.

In S1004, the new AT extraction rule generated in S1001 and each AT extraction rule included in the history information obtained in S1003 are compared to each other for each item attribute, and the processing executed next branches depending on whether there is a difference between the AT extraction rules. If there is a difference by the unit of the item attribute between the new AT extraction rule and the latest AT extraction rule, S1005 is executed next. On the other hand, if there is no difference by the unit of the item attribute between the new AT extraction rule and the latest AT extraction rule, and all the item attributes are the same, S1006 is executed next.

In S1005, processing to materialize or abstract the AT extraction rule generated in S1001 is performed by the unit of the item attribute based on the difference from the AT extraction rule generated in the past. In this case, the materialization of the AT extraction rule means to change the abstract item attribute to the detailed item attribute regarding the already-defined item attribute included in the rule. Additionally, the abstraction of the AT extraction rule means to change the detailed item attribute to the abstract item attribute regarding the already-defined item attribute included in the rule. In a case where the materialization of the AT extraction rule is performed, the extraction target range is narrowed, and in a case where the abstraction of the AT extraction rule is performed, the extraction target range is widened. Note that, as for <title> that is one of the abstract item attributes, since no corresponding detailed item attribute exists (undefined), <title> is excluded from the target of the materialization and the abstraction in the present step. Thus, the AT extraction rule subjected to the materialization or the abstraction by the unit of the item attribute is saved in the HDD 120, read in a case of the subsequent filing of the scanned image (the processing of obtaining the extraction rule, S504), and used.

### <<Example of Materialization of AT Extraction Rule>>

As described above, the materialization of the AT extraction rule has an effect of narrowing the extraction target range. With the materialization, for example, in a case where the item attributes included in the AT extraction rule include the abstract item attribute, it is possible to prevent a case where the document type is improperly estimated during new scanning in S513, and accordingly the idx character string cannot be extracted correctly. The above case is likely to occur particularly in a case where the same type of documents are scanned frequently. The improper extraction of the idx character string because of the excessively wide extraction target range is prevented by the materialization of the AT extraction rule. In the following Table 2, an example of the materialization of the AT extraction rule in the present embodiment is illustrated.

| | configuration contents of AT extraction rule | | | |
|---|---|---|---|---|
| | (extraction target item attribute) | | | |
| third | billing date | billing | distributing | billing amount |
| previous | | number | company name | |
| history | | | | |
| second | billing date | billing | distributing | billing amount |
| previous | | number | company name | |
| history | | | | |
| first previous | billing date | billing | distributing | billing amount |
| history | | number | company name | |
| newly | issue date | document | issuing | total amount |
| generated | | number | company name | |
| after | billing date | billing | distributing | billing amount |
| materiali- | | number | company name | |
| zation | | | | |

In this case, the newly generated AT extraction rule in Table 2 mentioned above is directly applied to a case of the next new scanning of “bill.” Now, since the newly generated AT extraction rule includes the item attribute <issuing company name>, in a case where the document type is improperly estimated as “order form” in S513, the recognized character string corresponding to the item attribute <purchasing company name> may be improperly extracted. In order to prevent the above-described improper extraction, the materialization of the AT extraction rule is performed in the present step.

Now, comparing with the abstract item attributes included in the newly generated AT extraction rule, all the past AT extraction rules indicated by the latest three times of histories include the detailed item attributes of the document type “bill.” Therefore, the abstract item attributes included in the newly generated AT extraction rule is changed to the corresponding detailed item attributes according to the document type “bill,” respectively. In other words, as indicated by the AT extraction rule after the materialization in Table 2 mentioned above, <issue date> is changed to <billing date>, <document number> is changed to <billing number>, <issuing company name> is changed to <distributing company name>, and <total amount> is changed to <billing amount>, respectively.

### <<Example of Abstraction of AT Extraction Rule>>

Subsequently, the abstraction of the AT extraction rule in the present embodiment is described. As described above, the abstraction of the AT extraction rule has an effect of widening the extraction target range. With the abstraction being performed, in a case where a part of the AT extraction rule includes the detailed item attribute, it is possible to prevent a case where the character string of the item attribute that is expected to be extracted cannot be extracted in a case of newly scanning a new type of the document. The above-described case may occur particularly in a case where a variety of documents are scanned frequently. The improper extraction of the idx character string because of the excessively narrow extraction target range is prevented by the abstraction of the AT extraction rule. In the following Table 3, an example of the abstraction of the AT extraction rule in the present embodiment is illustrated.

| item attribute | | | | |
|---|---|---|---|---|
| extraction | configuration contents of AT extraction rule | | | |
| rule | (extraction target item attribute) | | | |
| third | estimate date | estimate | distributing | estimate |
| previous | | number | company name | amount |
| history | | | | |
| second | order date | order | purchasing | order amount |
| previous | | number | company name | |
| history | | | | |
| first previous | billing date | billing | distributing | billing amount |
| history | | number | company name | |
| newly | billing date | billing | distributing | billing amount |
| generated | | number | company name | |
| after | issue date | document | issuing | total amount |
| materiali- | | number | company name | |
| zation | | | | |

In this case, the newly generated AT extraction rule in Table 3 mentioned above is obtained by succeeding the estimation of the document type as “bill” in S513 first, and also succeeding the estimation of each detailed item attribute according to the document type “bill” in the subsequent estimation of the already-defined item attribute. It is assumed that the AT extraction rule is directly applied to the next new scanning of “estimate form”. In this case, in a case where the new “estimate form” having no processing record is scanned, the recognized character string corresponding to the item attribute <estimate date> cannot be extracted. In order to prevent the above problem, the abstraction of the AT extraction rule is performed in the present step.

Now, although the detailed item attributes included in the newly generated AT extraction rule correspond to the document type “bill,” the detailed item attributes included in the past AT extraction rules indicated by the latest three times of histories correspond to the document types “bill,” “order form,” and “estimate form,” respectively. Therefore, the detailed item attributes included in the newly generated AT extraction rule are changed to the extraction target item attributes independent of the document type, respectively. In other words, as indicated by the AT extraction rule after the abstraction in Table 3 mentioned above, <billing date> is changed to <issue date>, <billing number> is changed to <document number>, <distributing company name> is changed to <issuing company name>, and <billing amount> is changed to <total amount>, respectively.

In S1006, update of the history of the AT extraction rule is performed. Specifically, processing to add the AT extraction rule generated in S1001 (the AT extraction rule before the materialization and the abstraction in S1005) to the history and delete the old AT extraction rule that needs to be deleted from the history is performed, for example. Once the update of the history is completed, the processing returns to S1002. The above is the contents of the AT extraction rule registration processing.

### Modification Example

In the above-described embodiment, in a case where it is improperly determined that there is the registered document that matches the unregistered new document in the document matching, the wrong idx character string is extracted by the AR extraction rule.

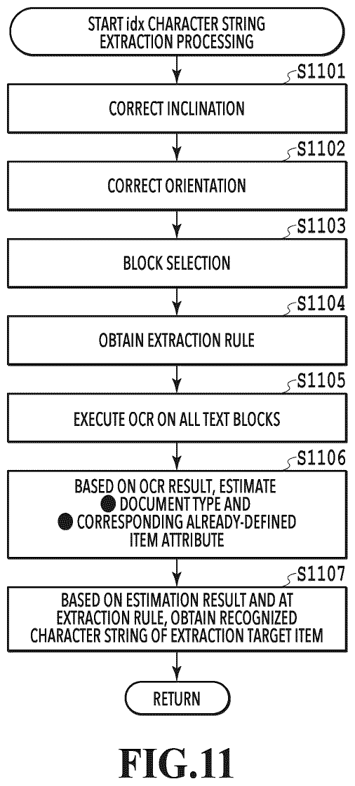

Therefore, the document matching may be omitted, and only the idx character string extraction by the AT extraction rule may be performed. In this case, first, even in a case where the idx character string is corrected by the property information setting processing (Yes in S404), the document registration processing (S405) is skipped. Then, also in the subsequent AT extraction rule registration processing (S406), the document matching (S505) and the subsequent idx character string extraction by the AR extraction rule (S508, S510) are not performed. FIG. 11 is a flowchart illustrating details of the AT extraction rule registration processing (S406) according to the present modification. In the following, description is provided along the flow in FIGS. 11.

S1101 to S1104 correspond to S501 to S504 in the flow in FIG. 5 described above, respectively. In other words, as with the above-described embodiment, each processing of the inclination correction (S1101), the orientation correction (S1102), the block selection (S1103), and the obtainment of the extraction rule (S1004) is executed on the scanned image of the inputted document. In this case, in the obtainment of the extraction rule (S1104), processing to read only the AT extraction rule from the HDD 120 and deploy to the RAM 119 is performed. Subsequently, S1105 to S1107 correspond to S512 to S514 in the flow in FIG. 5 described above, respectively. In other words, each processing of the whole-area OCR performed on the scanned image (S1105), the estimation of the document type and the already-defined attribute item based on the OCR result (S1106), and the extraction of the idx character string based on the result of the estimation and the AT extraction rule (S1107) is performed.

With the processing as described above, it is possible to reduce a case where the wrong idx character string is extracted based on the AR extraction rule in a case of newly scanning the document that has a similar layout with the previously scanned document but the attribute of the written item is different. In other words, in a case of the present modification, even in a case of the filing of the scanned image of the new document having a similar document layout but the attribute of the written item is different, it is possible to extract the character string corresponding to the desired item with high accuracy. Thus, the user can reduce the effort to correct the improperly extracted idx character string.

As described above, according to the present embodiment, it is possible to generate the item attribute-based extraction rule having no area dependency. Thus, the user can extract the idx character string with high accuracy even from the atypical document, for example.

### Second Embodiment

In the embodiment 1 including the modification, the predefined item attribute is estimated based on the recognized character string obtained by the whole-area OCR by a so-called rule-based estimation method. That is, the item attribute that is not predefined does not become a constituent of the AT extraction rule to be generated. Therefore, in a case of the method in the embodiment 1, in a case where it is determined that there is no matching registered document in the document matching, the recognized character string of the undefined item attribute cannot be extracted as the idx character string. For this reason, the user who wants to use the idx character string corresponding to the undefined item attribute as the file name and the like needs to manually designate the text block of the corresponding character string in the processing of setting the property information every time. Therefore, an aspect in which various item attributes are estimated by a text generation model regardless of whether the item attribute is predefined is described as an embodiment 2. Note that, since the system configuration and the flow of the filing of the document are common to the embodiment 1, in the following, the method of estimating the item attribute, which is a different point from the embodiment 1, is mainly described.

### <Text Generation Model>

The text generation model is a machine learning model that is obtained by learning using a great amount of text data and is a model generating a new text based on provided input data. Recent years, the text generation model has been used in various fields of text generation, translation, summarization, dialogue system, and the like. The text generation model includes a Transformer model and the like, for example. As a learning method, there are supervised learning and self-supervised learning. In the supervised learning, a learning model is trained by using a pair of text data prepared in advance and corresponding correct data. On the other hand, in the self-supervised learning, training proceeds with the machine learning model predicting a part of the text data by itself. In the present embodiment, the dialogue system of the text generation model is used to perform the estimation in the following procedure. First of all, the OCR result of the entire scanned image, the position (coordinate) information of the text block of the character string corresponding to the desired item, and the statement to instruct the estimation of the item attribute are inputted to the text generation model. Thus, inside the text generation model, natural language processing based on the inputted information is performed to estimate the item attribute of the character string corresponding to the desired item. Note that, in a case of using the Transformer model as a multimodal AI that can also perform image input, the input to the model may be the scanned image data before the OCR is performed.

### <Estimation of Item Attribute>

A specific example of the estimation of the item attribute using the text generation model according to the present embodiment is described with reference to FIG. 8 described above. First of all, the scanned image illustrated in FIG. 8, a coordinate [2102,520,103,64] of the text block “1001” on the right of “bill No.: ,” and the statement (prompt) instructing the estimation of the item attribute are inputted to the text generation model. The statement in this case is, for example, “Please estimate the item attribute of the character string in the inputted text block and output in a JSON format. Please output the item attribute by a word.” In a case of this statement, the estimation result structured in the JSON format is obtained for the character string of the designated text block. Specifically, an output in the format of {“character string area”: [2102,520,103,64], “character string”: “1001,” “item attribute”: “billing number”} is obtained. Thus, the item attribute <billing number> is obtained as the estimation result for the character string “1001.” Additionally, it is possible to estimate also the certainty of the estimation result (in the following, called “item attribute certainty”) by adding the instruction like “Please also output whether the estimation result has ‘high,’ ‘medium,’ or ‘low’ certainty.” to the statement. Thus, in a case where the multiple same item attributes are estimated from the scanned image as the processing target, it is possible to select one item attribute with higher reliability based on the item attribute certainty. Note that, the above-described statement is an example, and it is desirable to input the statement that corresponds to the characteristics of the text generation model.

### <Idx Character String Extraction Processing>

In a case where the item attribute is obtained by the estimation using the text generation model in S513 as described above, in S514 in the present embodiment, the extraction of the idx character string is performed for the extraction target item by using the text generation model similarly. Since the item attribute as the estimation target in S513 of the present embodiment is not predefined, there is a possibility that inconsistent notation occurs in the estimation result (estimated item attribute) obtained in S513. As an example of the inconsistent notation, <billing number> and <bill number>, <distributing company name> and <billing company name>, and the like may be considered. As a countermeasure for the above-described inconsistent notation, a list of the estimated item attribute obtained in S513, the extraction target item attribute, and the extraction statement are inputted to the text generation model. A specific example of each of the inputted information is as follows.

In a case where the above-described information is inputted, [{“character string area”: (abbreviated), “character string”: “1001,” “item attribute”: “billing number”}] is obtained as an output of the extraction result. In this extraction result, the inconsistent notation between <billing number> and <bill number> is absorbed. Thus, in the character string extraction processing using the text generation model of the present embodiment, even in a case where the notation of the estimated item attribute and the notation of the extraction target item attribute do not completely match, it is possible to extract the idx character string. This is because the text generation model is learned by using a great amount of text data including context and expresses a word as a feature vector, and thus it is possible to understand a word that has various wording with similar feature vectors as a word having a similar meaning.

As described above, according to the present embodiment, the item attribute is estimated from the scanned image of the inputted document by the text generation model without defining the item attribute in advance. Therefore, it is possible to generate the AT extraction rule that can be applied to various item attributes, and a case where the user cannot extract the idx character string that the user wants to use as the file name and the like is reduced. Thus, comparing with the embodiment 1, it is possible to reduce a scene in which no idx character string is extracted, and it is possible to reduce the effort of the user to manually designate the text block in a case of setting the property information, for example.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to easily create a proper extraction rule to extract a character string corresponding to a desired item in a document.

This application claims the benefit of Japanese Patent Application No. 2025-012772, filed Jan. 29, 2025, which is hereby incorporated by reference herein in its entirety.

What is claimed is:

1. An information processing apparatus comprising:
at least one memory that stores a program; and
at least one processor that executes the program to perform:
receiving designation of an area from a user on a first image;
saving a string type of a character string identified by estimation processing based on the character string included in the designated area; and
outputting a character string, corresponding to the saved string type, that is extracted from a plurality of character strings recognized from a second image.

2. The information processing apparatus according to claim 1, wherein
in the estimation processing, estimation of a predefined string type of a character string is performed.

3. The information processing apparatus according to claim 2, wherein
the predefined string type includes a first type independent of a kind of a document and a second type obtained by detailing the first type according to a kind of the document.

4. The information processing apparatus according to claim 3, wherein
in the estimation processing, estimation of a kind of the document for the first image is additionally performed, and
estimation of the second type is performed based on an estimation result of the kind of the document and an estimation result of the first type.

5. The information processing apparatus according to claim 1, wherein
the at least one processor that executes the program to further perform the estimation processing.

6. The information processing apparatus according to claim 5, wherein
a rule-based method or a machine learning model is used for the estimation processing.

7. The information processing apparatus according to claim 1, wherein
the at least one processor that executes the program to further perform:
saving history information of the string type; and
detailing or abstracting the string type identified by the estimation processing in a case where there is a difference between the identified string type and the string type included in the saved history information.

8. The information processing apparatus according to claim 1, wherein
the first image and the second image are atypical images.

9. An information processing method comprising:
receiving designation of an area from a user on a first image;
saving a string type of a character string identified by estimation processing based on the character string included in the designated area; and
outputting a character string, corresponding to the saved string type, that is extracted from a plurality of character strings recognized from a second image.

10. A non-transitory computer readable storage medium storing a computer program to execute an information processing method, the information processing method comprising:
receiving designation of an area from a user on a first image;
saving a type of a character string identified by estimation processing based on the character string included in the designated area; and
outputting a character string corresponding to the saved type that is extracted from a plurality of character strings recognized from a second image.
